(19) United States
(12) Patent Application Publication
(10) Pub. No.: US 2015/0230423 A1
(43) Pub. Date: Aug. 20, 2015

(54) Method, Use And Apparatus For Continuous Reversal Or Breaking Of An Oil-In-Water Emulsion Food Product By Means Of Hydrodynamic Cavitation

(71) Applicant: SPX FLOW TECHNOLOGY DANMARK A/S, Silkeborg (DK)

(72) Inventors: Christian Kjolby, Hojbjerg (DK); Bent Pedersen, Hojbjerg (DK); Claus Riis, Laven (DK)

(21) Appl. No.: 14/428,332

(22) PCT Filed: Sep. 6, 2013
(86) PCT No.: PCT/EP2013/068443

§ 371 Date: Mar. 13, 2015

(30) Foreign Application Priority Data
Sep. 14, 2012 (DK) PA 2012 00566

(51) Int. Cl. A01J 15/10; A23L 1/48; A23D 7/02; B01F 3/08; A23C 15/02

(52) U.S. Cl. CPC A01J 15/10; B01F 3/0807; A23C 15/02; A23D 7/02; A23L 1/483; A23V 2002/00; B01F 2215/0016

(57) ABSTRACT

A method where a continuous flow of an oil-in-water emulsion is fed to a cavitator (10), the oil-in-water emulsion is tempered and then reversed or broken in the cavitator (10) and a continuous flow of water-in-oil emulsion or broken oil-in-water emulsion is discharged out of the cavitator (10). The oil-in-water emulsion can contain water, milk, cream, and/or recombined liquids. The reversed emulsion can be a low-fat butter or a low-fat margarine. The broken oil-in-water emulation can leave the cavitator as butter fat and butter milk. Use of cavitation or of a cavitator (10) to reverse or break an oil-in-water emulsion. An apparatus (1) with a feed pump (5) and a cavitator (10), a first heat exchanger (7) for tempering a flow of an oil-in-water emulsion pumped by the feed pump (5) to the cavitator (10) and a second heat exchanger (15) for cooling a water-in-oil emulsion or for cooling a broken oil-in-water emulsion that is pumped from the cavitator (10) through the second heat exchanger (15).

### FIELD OF THE INVENTION

The present invention relates generally to reversing or breaking an oil-in-water emulsion food products. More particularly, the present invention relates to a method, use and apparatus for reversing or breaking an oil-in-water emulsion food product.

### BACKGROUND OF THE INVENTION

Conventional methods for breaking or reversing an oil-in-water emulsion food products are e.g. used in the making of butter.

In known methods, the cream (oil-in-water emulsion) is fed into a churning cylinder fitted with beaters that are driven by a variable speed motor.

Breaking up of the cream takes place in the cylinder and, when finished, the butter grains and buttermilk (that are now separate emulsions) pass on to a draining section. The first washing of the butter grains sometimes takes place en route—either with water or recirculated chilled buttermilk. The working of the butter commences in the draining section by means of a screw, which also conveys it to the next stage.

On leaving the working section, the butter passes through a conical channel to remove any remaining buttermilk. Immediately afterwards, the butter may be given its second washing, this time by two rows of adjustable high-pressure nozzles. The water pressure is so high that the ribbon of butter is broken down into grains and consequently any residual milk solids are effectively removed.

In the final or mixing section the butter passes a series of perforated disks and star wheels. There is also an injector for final adjustment of the water content. Once regulated, the water content of the butter deviates less than +/−0.1%, provided the characteristics of the cream remain the same.

The finished butter is discharged in a continuous ribbon from the end nozzle of the machine and then into the packaging unit.

U.S. Pat. No. 3,332,615 discloses an apparatus and method for separating cream from milk. The concentrated cream is further processed by the apparatus by exposure to cavitation in order to produce butter oil and butter milk as separate products. This apparatus is relatively complicated and focused on producing butter oil, i.e. the watery contend of the cream is removed to a large extend from the oily part.

Accordingly, it is desirable to provide a method, use and apparatus that is simpler and less costly than known technologies. Further, it is desirable to provide a completely new process for making products such as low fat butter, butter blends, low fat spreads and butter by emulsion breakage or reversal, by keeping substantially all of the watery product in the oily product, i.e. without separating the oily product and the watery product.

### SUMMARY OF THE INVENTION

The present invention offers a new simpler way of reversing or breaking oil-in-water emulsion food products where the oily product and the watery product that go into the process are together in one emulsion at the outcome of the process, in order to produce e.g. low fat spread thus eliminating the butter fat production step and subsequent addition to a low fat butter emulsion.

The foregoing needs are met, to a great extent, by the embodiments of the present invention.

In one aspect a method is provided for continuous reversal or breaking of an oil-in-water emulsion food product. In an embodiment the method comprises feeding a continuous flow of tempered oil-in-water emulsion food product into a cavitator, causing cavitation in the tempered oil-in-water emulsion food product inside the cavitator thereby breaking the oil-in-water emulsion food product or thereby reversing the oil-in-water emulsion food product to a water-in-oil emulsion food product, and discharging a continuous flow of broken oil-in-water emulsion food product or a continuous flow of reversed water-in-oil emulsion food product out of the cavitator.

Thus, a continuous flow of a low fat reversed or broken emulsion food product is the only product coming out of the cavitator and because the watery part has not been separated from the oily part the resulting food product emulsion has a high water content and thus a low fat content.

According to another aspect, the tempered oil-in-water emulsion that is fed to the cavitator is reversed into water-in-oil emulsion by hydrodynamic cavitation inside the cavitator and a single continuous flow of water-in-oil emulsion is produced with the cavitator.

According to another aspect, the tempered oil-in-water emulsion that is fed to the cavitator is broken inside the cavitator and the liquid discharged from the cavitator has an oily liquid component and a watery liquid component that are not dispersed in one another.

According to another aspect, the method further comprising adding and mixing vegetable oil into the emulsion either before or after the reversal in order to create a more flat crystallization profile of the resulting emulsion.

According to another aspect, the continuous flow of water-in-oil emulsion coming out of the cavitator is cooled.

According to another aspect, the oil-in-water emulsion that is pumped into the cavitator is pasteurized before entering the cavitator.

According to another aspect, the backpressure of the emulsion leaving the cavitator is within the range of 0.5 to 7.5 bar, preferably 1.5 to 5 bar.

According to another aspect, the oil-in-water emulsion that is pumped to the cavitator has a fat content in the range of 25 to 65%.

According to another aspect, the oil in the oil-in-water emulsion is an animal fat or vegetable fat or a mixture of animal fat and vegetable fat.

According to another aspect, the animal fat or vegetable fat is liquid, solid, inter-esterified, fractionated or hydrogenated.

According to another aspect, the emulsion fed to the cavitator contains water, milk, cream, and/or recombined liquids.

According to another aspect, the resulting water-in-oil emulsion is butter or margarine, preferably a low fat butter or low fat margarine.

According to another aspect, the emulsion fed to the cavitator is a cream that is broken in the cavitator into butter fat and buttermilk, and said method preferably includes further separating the flow of fluid coming from the cavitator into a continuous flow of butter and a continuous flow of buttermilk.

According to another aspect, the emulsion fed to the cavitator is a low-fat spread emulsion wherein the fat has not yet crystallized, and the low-fat spread emulsion is broken inside the cavitator.

In another aspect of the invention, a use of cavitation for reversing or breaking an oil-in-water emulsion is provided. Using cavitation instead of conventional methods, e.g. beating, for reversing or breaking an oil-in-water emulsion is simpler and less costly than known technologies.

According to an aspect, the cavitation is used in a continuous flow of oil-in-water emulsion to produce a continuous flow of broken oil-in-water emulsion or to produce a flow of water-in-oil emulsion.

In another aspect of the invention, an apparatus for reversing or breaking an oil-in-water emulsion is provided. In an embodiment the apparatus for breaking or reversing an oil-in-water emulsion comprises a source of pressurized oil-in-water emulsion, a cavitator with cavitation chamber, the cavitation chamber being provided with an inlet and with an outlet, the inlet being in fluid connection with the source of pressurized oil-in-water emulsion, a first heat exchanger for tempering a flow of oil-in-water emulsion flowing to the inlet of the cavitator, a second heat exchanger for cooling the emulsion that is discharged from the outlet of the cavitator.

According to another aspect, the cavitator is configured for breaking the oil-in-water emulsion in the cavitator chamber or configured for reversing the oil-in-water emulsion in the cavitation chamber.

According to yet another aspect, the apparatus further comprises a backpressure valve arranged downstream of the cavitator and configured for maintaining a desired backpressure at the outlet of said cavitator so that said oil-in-water emulsion is either reversed or broken in said cavitator.

According to yet another aspect, the apparatus further comprises a separator for separating a continuous flow of broken emulsion into a continuous flow of watery liquid and a continuous flow of an oily liquid.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction or to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

In the following detailed portion of the present description, the invention will be explained in more detail with reference to the exemplary embodiments shown in the drawings, in which:

FIG. 1 is a diagrammatic view of an apparatus for reversing or breaking an oil-in-water emulsion according to an example embodiment of the present invention,

FIG. 2 is a sectional diagrammatic view of a cavitator of the apparatus shown in FIG. 1 and an electric drive motor operably coupled to the cavitator,

FIG. 3 is a cross-sectional view of the cavitator of FIG. 1 in a first example embodiment,

FIG. 4 is a cross-sectional view of the cavitator of FIG. 1 in a second example embodiment, and

FIG. 5 is a diagrammatic view of an apparatus for reversing or breaking an oil-in-water emulsion according to FIG. 1 with an additional separator.

### DETAILED DESCRIPTION OF PREFERRED EMBODIMENTS

Example embodiments of the invention will now be described with reference to the drawing figures, in which like reference numerals refer to like parts throughout. An embodiment in accordance with the present invention provides a food apparatus for reversing or breaking an oil-in-water emulsion food product.

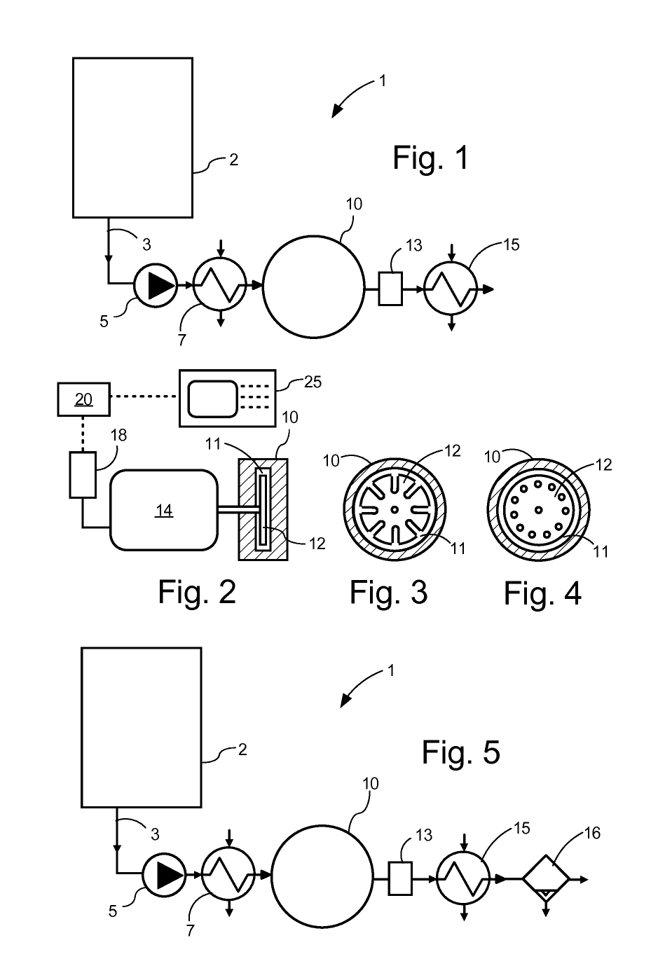

FIG. 1 illustrates an example embodiment of a food apparatus for reversing or breaking an oil-in-water emulsion food product. The food apparatus 1 may include a container 2 for holding an oil-in-water emulsion food product. In other embodiments, the oil-in-water emulsion food product may be delivered from a container that is not part of the apparatus 1. A conduit 3 connects the container 2 to the inlet of a feed pump 5. The outlet of the feed pump 5 is connected by a conduit to the inlet of a first heat exchanger 7, such as for example, but not limited to, a plate heat exchanger, tubular heat exchanger or scraped surface heat exchanger. All of the components are suitable for use with food products, i.e. the apparatus and its components are designed, fabricated, constructed, and installed according to sound sanitary design principles. This apparatus is designed and constructed so that it can be adequately cleaned and sanitized, and its surfaces are resistant to daily exposure to corrosive food products and cleaning/sanitizing chemicals.

The outlet of the first heat exchanger 7 is connected by a conduit to an inlet of a cavitator 10. An outlet of the cavitator 10 is connected by a conduit to the inlet of a second heat exchanger 15. A backpressure valve 13 is arranged in the conduit connecting the outlet of the cavitator 10 to the inlet of the second heat exchanger 15.

The second heat exchanger 15 is for example, but not limited to, a plate heat exchanger, tubular heat exchanger or scraped surface heat exchanger. The second heat exchanger 15 has an outlet that in the present embodiment forms the outlet of the apparatus 1.

In an embodiment, the described components of the apparatus 1 can be mounted on a frame or the like (not shown).

In an embodiment, temperature transmitters (sensors) are located between the first heat exchanger 7 and the cavitator and at or just after the outlet of the second heat exchanger 15. In an embodiment, a flow-meter, such as for example a magnetic flow meter, is provided at a desired position between the outlet of the container 2 and the inlet of the second heat exchanger 15. In an embodiment, pressure indicators (sensors) are also provided. A least one pressure indicator (sensor) is provided between the outlet of the feed pump 5 and the inlet of the cavitator 10. In an embodiment, there is provided a pressure indicator (sensor) between the feed pump 5 and the first heat exchanger 7 and between the first heat exchanger 7 and the cavitator 10. In an embodiment, another pressure indicator is provided between the cavitator 10 and the second heat exchanger 15. In an embodiment there are also temperature transmitters (sensors) in the container 2, along conduit 3, and in between the cavitator 10 and the second heat exchanger 15.

As more particularly shown in FIG. 2, the cavitator 10 has a housing with a cavitation chamber 11 therein. A cavitator disk 12 is rotatably suspended inside the cavitation chamber 11. In an embodiment, the cavitation disk 12 is driven by an electric drive motor 14, such as for example an AC or DC drive motor for spinning the cavitator disk at a desired rotational speed. A frequency converter 18 controls the DC motor 14. A controller 20, such as an electronic control unit receives the signals from the temperature sensors, the pressure sensors, the flow sensor and from a control panel 25 with a user interface that can be used by an operator. The controller sends information from the sensors to the control panel 25 and the control panel 25 may in an embodiment be provided with a display to show the sensor information to an operator. The controller 20 also sends a DC motor speed control signal to the frequency controller 18. According to another embodiment the rotational speed of the cavitator 14 is controlled manually with a fixed speed, independent of the controller 20 signal received.

FIG. 3 is a cross-sectional view of the cavitator 10 showing the outline of the cavitator wheel 12 according to one embodiment. In this embodiment, the cavitator disk 12 is provided with a plurality of radially extending slots that cause controlled hydrodynamic cavitation in the fluid inside the cavitation chamber 11 when the cavitator disk 12 is spinning.

FIG. 4 is a cross-sectional view of the cavitator 10 showing the outline of the cavitator wheel 12 according to another embodiment. In this embodiment, the cavitator disk 12 is provided with a plurality of holes (circular holes are shown, but elliptical or similar shapes are also possible) that cause controlled hydrodynamic cavitation in the fluid inside the cavitation chamber 11 when the cavitator disk 12 is spinning.

As otherwise discussed herein, the apparatus used in the inventive methods and systems can be useful for reversing or breaking an oil-in-water emulsion food product.

Returning to FIG. 1, the oil-in-water emulsion food product contained in the container 2 flows through conduit 3 to the inlet of the feed pump 5. The feed pump 5 feeds oil-in-water emulsion food product to the first heat exchanger 7, thereby causing a continuous flow of liquid through the apparatus 1. A heating fluid, such as for example water or steam, with a controlled temperature and flow rate flows also through the first heat exchanger 7. In the first heat exchanger, the oil-in-water emulsion is tempered to a desired temperature. In an embodiment, the oil-in-water emulsion is pasteurized and then tempered by means of the first heat exchanger 7.

From the first heat exchanger 7 the oil-in-water emulsion food product is pumped/fed to the hydrodynamic cavitation device 10 where it is subjected to hydrodynamic cavitation. The cavitator 10 can be the APV™ Cavitator sold and manufactured by SPX® Corporation, Charlotte, N.C., USA. The impact from the cavitation exposure either breaks or reverses the emulsion, leading to a continuous production of a single water-in-oil emulsion food product or to a continuous production of a single liquid wherein the watery component and the oily component previously forming the emulsion are no longer dispersed in one another, but phase-separated food product. The reversal or braking up process is controlled by the e.g. the temperature of the oil-in-water emulsion entering the cavitator 10 and by the backpressure of the emulsion or the phase-separated emulsion leaving the cavitator 10. The process is also dependent on the composition of the oil-in-water emulsion, the temperature profile, the flow rate and on the characteristics and operation of the cavitator 10.

From the outlet of the cavitator 10, the single water-in-oil emulsion food product or the single phase-separated emulsion food product with a watery component and an oily component is pumped/fed via the backpressure valve 13 to the second heat exchanger 15. The backpressure valve 13 regulates the pressure of the fluid coming into the back pressure valve. The backpressure valve 13 is connected to the controller 20 and an operator can select the setting for the backpressure valve 13 via the operator panel 25.

The reversed emulsion or phase-separated emulsion is cooled by means of the second heat exchanger 15. Hereto, a cooling fluid, such as e.g. water, with a controlled temperature and flow rate is also flowed through the second heat exchanger 15.

Thus, the cavitation is used to reverse or break the oil-in-water emulsion food product into a single water-in-oil emulsion food product. The single food product emulsion coming out of the cavitator 10 and coming out of the apparatus has the same fat content and the same water content as the ingoing oil-in-water emulsion since the oily content and the watery content of the ingoing oil-in-water emulsion are not separated. This allows the production of a water-in-oil emulsion food product, such as e.g. a low fat butter in one step from cream. The fat content and the water content of the resulting low fat butter will be the same as the fat content and the water content of the ingoing cream.

As an example of a method according to an embodiment of the invention, a cream with a fat content of 48% (double cream) is pasteurized and tempered to approximately 15° C. (10-20° C. range) in the first heat exchanger 7 and pumped at 1800 L/H into the cavitation unit 10 (where it is reversed and a continuous production of low-fat butter is produced (water-in-oil emulsion). The backpressure leaving the cavitator 10 is within the range of 0.5 to 7.5 bar, preferably in the range of 1.5 to 5 bar. There is no separation of buttermilk, and thus a continuous flow of low fat (high water) butter comes out of the outlet of the second heat exchanger 15.

In an embodiment, vegetable oil is added to mix into the emulsion either before or after the reversal in the cavitator 10 in order to create a more flat crystallization profile that again will lead to a more stable product.

In another embodiment a low-fat spread emulsion is reversed in the cavitator 10 before the crystallization of the fat. The emulsion is thereafter crystalized in a scraped surface heat exchanger, such as the Perfector line of scraped surface heat exchangers sold by Gerstenberg Schroder, a part of SPX® Corporation.

In another embodiment the oil-in-water emulsion is fed directly in to the cavitator 10, without any heat exchangers 7,15 before and after the cavitator 10 and/or without the back pressure valve 13 after the cavitator. Also, in an embodiment the feed pump 5 is omitted, e.g. when if the cavitator 10 is fed by other means like gravity or from a pressurized tank.

In an embodiment, the oil-in-water emulsion food product that is fed to the cavitator 10 has a fat content range of 25-65%, preferably 35% to 50% and even more preferably 40% to 45%. The water-in-oil emulsion leaving the cavitator has the same fat content as the oil-in-water emulsion that is fed to the cavitator

In another embodiment, the oil-in-water emulsion food product that is fed to the cavitator 10 is a double cream, preferably a 48% double cream.

In an embodiment, the oil in the oil-in-water emulsion that is fed to the cavitator may be an animal fat or vegetable fat or a mixture of animal fat and vegetable fat. In an embodiment, the animal fat or vegetable fat is liquid, solid, inter-esterified, fractionated or hydrogenated.

In an embodiment, the emulsion pumped to the cavitator 10 contains water, milk, cream, and/or recombined liquids

Turning now to FIG. 5, another embodiment of the apparatus 1 is shown for reversing an oil-in-water emulsion food product and separating the liquid phases. The apparatus shown in FIG. 5 is essentially identical to the apparatus shown in FIG. 1, except that a separator 16 has been added after the second heat exchanger 15. The outlet of the second heat exchanger is connected by a conduit to the inlet of a separator 16 that has two outlets, one for each phase of the phase-separated emulsion.

In an embodiment, cream is pumped by the feed pump 5 from the container 2, through the first heat exchanger 7 and into the cavitator 10. The cream is tempered by the first heat exchanger 7 and the cream is broken into butter fat and butter milk in the cavitator 10 (such as e.g. the APV™ Cavitator sold and manufactured by SPX® Corporation, Charlotte, N.C., USA). The phase-separated liquid flows from the cavitator 10 via the backpressure valve 13 to the second heat exchanger 15 where it is cooled. From the second heat exchanger 15 the phase-separated liquid flows to the separator 16 and a continuous flow of buttermilk comes out of one of the outlets of the separator 16 and a continuous flow of butter fat comes out of the other outlet of the separator 16.

In an embodiment the cavitator 10 is provided with two outlets and the separation of the two fluids is performed in the cavitator 10. Alternatively, the cavitator and the separator are combined into one integrated machine.

In an embodiment the first heat exchanger 7 and the second heat exchanger 15 are one and the same so that the waste heat from the product downstream of the cavitator is reused for heating the product fed to the cavitator 10

The separator 16 can also work without a cooler 15 after the cavitator 10. The heat exchanger 15 can in an embodiment be a heater, since oil (not butter) is more efficient separated in a separator at high temperatures due to lower oil viscosities.

Although the embodiments described above illustrate the invention in relation to a mechanical cavitator, it is understood that the cavitation can be applied to the emulsion by other non-mechanical means, such as e.g. ultrasonic cavitation.

The invention has numerous advantages. Different embodiments or implementations may yield one or more of the following advantages. It should be noted that this is not an exhaustive list and there may be other advantages which are not described herein. One advantage of the invention is that it provides a simple method with only one step and continuous processing for reversing or breaking an oil-in-water emulsion food product and turning it into a single water-in-oil emulsion food product. It is another advantage of the invention that it leaves a small footprint. It is yet another advantage of the invention that it provides for an apparatus and method with low maintenance cost. It is yet another advantage of the invention that it provides for lower operating expenses for reversing or breaking an oil-in-water emulsion food product. It is yet another advantage of the invention that it provides improved product quality of reversed or broken oil-in-water emulsion food product. It is yet another advantage of the invention that it provides for flexible production of reversed or broken oil-in-water emulsion food product. It is yet another advantage of the invention that it provides for a low fat butter.

The term “comprising” as used in the claims does not exclude other elements. The term “a” or “an” as used in the claims does not exclude a plurality.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

Although the present invention has been described in detail for purpose of illustration, it is understood that such detail is solely for that purpose, and variations can be made therein by those skilled in the art without departing from the scope of the invention.

1. A method for continuous reversal or breaking of an oil-in-water emulsion food product, said method comprising:
feeding a continuous flow of tempered oil-in-water emulsion food product into a cavitator,
causing cavitation in the tempered oil-in-water emulsion food product inside said cavitator thereby breaking the oil-in-water emulsion food product or thereby reversing the oil-in-water emulsion food product to a water-in-oil emulsion food product,
discharging a single continuous flow of broken oil-in-water emulsion food product or a single continuous flow of reversed water-in-oil emulsion food product from said cavitator.

2. The method according to claim 1, wherein the tempered oil-in-water emulsion food product that is fed to the cavitator is reversed into a water-in-oil emulsion food product by hydrodynamic cavitation inside the cavitator and a single continuous flow of water-in-oil emulsion food product is coming out of said cavitator.

3. A method according to claim 1, further comprising adding and mixing vegetable oil into the emulsion either before or after the reversal in order to create a more flat crystallization profile of the resulting emulsion.

4. The method according to claim 1, wherein the tempered oil-in-water emulsion food product that is fed to the cavitator is broken inside the cavitator and the phase-separated emulsion food product that flows out of the cavitator has an oily liquid component and a watery liquid component with the oily component and the watery component in a single emulsion.

5. The method according to claim 1, wherein the single continuous flow of water-in-oil emulsion food product coming out of said cavitator is cooled.

6. The method according to claim 1, wherein the oil-in-water emulsion food product that is fed into the cavitator is pasteurized before entering the cavitator.

7. A method according to claim 1, wherein the backpressure of the emulsion leaving the cavitator is within the range of 0.5 to 7.5 bar, preferably 1.5 to 5 bar.

8. A method according to claim 1, wherein the oil-in-water emulsion food product that is fed to the cavitator has a fat content in the range of 25 to 80%.

9. A method according to claim 1, wherein the water-in-oil emulsion food product coming out of the cavitator has a fat content that is equal to the fat content of the oil-in-water emulsion food product that is fed to the cavitator.

10. A method according to claim 1, wherein the oil in the oil-in-water emulsion comprises an animal fat or vegetable fat or a mixture of animal fat and vegetable fat, preferably said animal fat or vegetable fat is liquid, solid, interesterified, fractionated or hydrogenated.

11. A method according to claim 1, wherein the emulsion fed to the cavitator contains water, milk, cream, and/or recombined liquids.

12. A method according to claim 1, wherein the resulting water-in-oil emulsion is a low-fat butter or low-fat margarine.

13. A method according to claim 3, wherein the emulsion fed to the cavitator is a low-fat fat spread emulsion wherein the fat has not yet crystallized, and the low-fat spread emulsion is broken inside the cavitator.

14. Use of cavitation or of a cavitator for reversing or breaking an oil-in-water emulsion in a continuous flow of oil-in-water emulsion to produce a continuous flow of a single broken oil-in-water emulsion or to produce a single flow of water-in-oil emulsion.

15. An apparatus for breaking or reversing an oil-in-water emulsion food product, said apparatus comprising:
a source of pressurized oil-in-water emulsion food product,
a cavitator with cavitation chamber, said cavitation chamber being provided with an inlet and with an outlet, said inlet being in fluid connection with said source of pressurized oil-in-water emulsion food product,
a first heat exchanger for tempering a flow of oil-in-water emulsion food product flowing to the inlet of said cavitator,
a second heat exchanger for cooling the emulsion that is discharged from the outlet of said cavitator.

16. An apparatus according to claim 15, wherein said cavitator is configured for breaking the oil-in-water emulsion in the cavitation chamber into a single water-in-oil emulsion or configured for reversing the oil-in-water emulsion in the cavitation chamber into a single water-in-oil emulsion.

17. An apparatus according to claim 15, further comprising a backpressure valve arranged downstream of the cavitator and configured for maintaining a desired backpressure at the outlet of said cavitator so that said oil-in-water emulsion food product is either reversed or broken in said cavitator.
